(19) United States
(12) Patent Application Publication
(10) Pub. No.: US 2005/0273434 A1
(43) Pub. Date: Dec. 8, 2005

(54) System and method for managing security in a supply chain

(76) Inventor: Allen Lubow, Brooklyn, NY (US)

Correspondence Address: BROWN, RAYSMAN, MILLSTEIN, FELDER & STEINER LLP, 900 THIRD AVENUE, NEW YORK, NY, 10022, US

(21) Appl. No.: 11/108,599

(22) Filed: Apr. 18, 2005

Related U.S. Application Data
(63) Continuation-in-part of application No. 11/069,579, filed on Mar. 1, 2005.
(60) Provisional application No. 60/563,482, filed on Apr. 18, 2004.

(51) Int. Cl. G06F 17/60

(52) U.S. Cl. 705/59

(57) ABSTRACT

Systems and methods for managing the licensing of a brand are provided. In one method, a request from a first party, e.g., a potential licensee, to license a brand associated with a second party, e.g., a brand owner, is received at a computer. If the second party approves the request, the first party may be enabled to order security devices through the computer. Each security device may comprise an optically variable device, such as a hologram, in which a bar code is rendered and a serialized human readable symbol. The computer may cause the ordered security devices to be shipped to the first party. The computer may cause an account of the first party to be debited by an amount based on the security devices ordered. The computer may cause portions of this amount to be credited to accounts of the second party and an operator of the computer.

### CROSS-REFERENCE TO RELATED APPLICATIONS

The present application claims the benefit under 35 U.S.C. § 119(e) from provisional patent application No. 60/563,482, filed Apr. 18, 2004, the contents of which is incorporated by reference herein its entirety. The present application is also a continuation-in-part of and claims the benefit under 35 U.S.C. § 120 from patent application Ser. No. 11/069,579, filed Mar. 1, 2005, the content of which is also incorporated by reference herein its entirety.

### COPYRIGHT AND LEGAL NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND OF THE INVENTION

The present invention relates generally to the management of supply chains and, more particularly, to a system and method for managing a supply chain in a secure manner.

### SUMMARY OF THE INVENTION

Companies (and licensors) that are faced with counterfeiting and gray market threats to their global supply chains may apply a security device that provides a means for validating the authenticity of a product (e.g., via information contained thereon that may be correlated with information stored in a database) with which it is associated (e.g., attached to). For example, these companies may apply brand security “markings” and Certificates of Authenticity (“COA”) to products. This is done in order to secure brands and preserve their intellectual property rights. According to an aspect of the system and method of the present invention the quantity and utilization of security devices used by licensees may be monitored to, ensure each legitimate product is authenticated in the supply chain from manufacturer to consumer.

According to an embodiment of the present invention, a rules-based customizable system is provided that may be configured to the specific functional requirements of any given supply chain. The system and method may provide functionality, such as, control for different types of security products, which may include, but is not limited to, generic COA (where each COA is the same as another), serialized COA's (where a unique number is applied to each unit for sale), and variable-printed COA's (where specific data such as size or SKU is printed on each of the COA's).

Other system functionality may include online ordering and adjustments to orders that may be input or changed by licensees and contract factories, whereby these changes may be monitored and controlled in accordance with specific business rules and authorizations; management and measurement of excess/unallocated COA's, which may have been shipped to each factory due to order quantity differences from EOQ/package quantities may be identified and quarantined for destruction; automatic notification of key events, such as, order and shipment confirmations; secure receipt confirmation and verification of COA shipments and activation of COA's; facilitation and tracking of the shipping process for COA's from source of manufacture to point of application, which includes pick list generation, packing slip generation and invoice creation, and shipment tracking and notification; memorializing chain of custody tracking; management of scrap quantities and monitoring the destruction of scrap COA's; and the provisions of a configurable reporting platform with a set of standard brand security reports for simplifying and standardizing the reporting of results. For example, in the management and measurement of excess/unallocated COA's, a licensee's company may have manufactured less product items than the quantity of COA's ordered for these manufactured products. In this case, the excess COA's must be accounted for and destroyed in order to avoid facilitating their reuse on other third party products, for which no license has been purchased.

The System may also provide the management and subsequent tracing of individual COA serial numbers (e.g., “for what order, to what factory, and when was serial number A12B345 sent?”)

According to one embodiment of the present invention, one type of COA may include a “serialized holographic bar coded” merchandise tag or adhesive sticker. In addition to a hologram, any type of optical variable device or optical security device may be used. Moreover, other types of COAs, as mentioned above (e.g., generic, serialized, variable printed) may also be used.

According to another embodiment of the invention, licensees may purchase COAs from the operator of a Supply Chain Security Management (SCSM) System. The Brand Owner may receive revenue at the time the COAs are purchased. The Brand Owner's level of revenue for each COA may be according the license agreement with the licensee. The operator of the SCSM System may receive a fee or percentage amount for each COA sold. Thus, no billing may be needed after the fact, e.g., monies from a licensee go to the Brand Owner and the operator of the SCSM System at the time each COA is purchased.

According to another embodiment of the invention, a consumer may check the authenticity of a licensed product by logging onto the SCSM System and entering a code (e.g., serial number) associated with the COA that may include a human readable number. Accordingly, the COA may comprise a machine-readable portion (e.g., a linear or two-dimensional bar code) and a human readable portion, which includes a serial number. The SCSM System may verify the entered code against data in its database and inform the consumer whether the item is authentic. A secondary consumer who may have bought the product from the original customer who purchased the item retail, could also verify the authenticity of the item in the same manner (e.g., logging onto the SCSM System, entering the human readable number encoded on the COA, and receiving confirmation as to the authenticity of the item).

According to another embodiment of the invention, the COA may use a novel machine-readable symbol, such as, a Reduced Space Symbology (RSS) bar code. The novel RSS bar code comprises a standard RSS bar code with additional proprietary information embedded. The standard portion associated with the bar code may comprises a standard bar code format such as Code 39 and RSS-14. Such a novel RSS bar code may be read with a standard RSS bar code scanner which would be able to read all the data encoded in, for example, the RSS bar code except for the additional proprietary information. A novel RSS bar code scanner designed to recognize the novel RSS bar code, may read the standard RSS bar code (e.g., RSS-14) information as well as the additional proprietary information embedded in the RSS bar code. For example, the additional proprietary information embedded may be accessed by programming the proprietary scanner device to read a particular pattern or series of symbols associated the RSS bar code. For example, the scanner may be programmed to read symbols according to a defined algorithm. For example, the algorithm may program the scanner to read symbols one, three, five, and seven in order to access the proprietary information.

This additional information could be embedded in the standard bar code by informing the proprietary scanner how the additional proprietary information may be extracted. Thus, a standard RSS bar code scanner would read the novel RSS bar code and see only the standard RSS bar code information. However, the proprietary RSS bar code scanner could be programmed to interpret the novel RSS bar code to extract the embedded information. Such a novel RSS bar code and corresponding scanner may provide a means for additional security, for parties aware of, and capable of, scanning the additional embedded information.

According to an embodiment of the present invention, a method of licensing a brand is provided. The method comprises receiving, at a computer, a request from a first party to license a brand associated with a second party. A request is forwarding by the computer to the second party. The computer then authorizes the receipt of one or more security devices by the first party based on the computer receiving approval of the request by the second party. The security device comprises an optically variable device contained within a carrier associated with a substrate. A bar code is rendered in the optically variable device, where a serialized human readable symbol is provided on a surface associated with the substrate. The computer then debits an amount from an account associated with the first party based on the first party receiving the security devices. The computer also deposits a first portion of the amount in a first account and a second portion of the amount in a second account, whereby the first account is associated with the second party and the second account is associated with an operator of the computer.

According to another embodiment of the present invention, the computer authorizes the receipt of the one or more security devices by submitting an order for the security devices to a production facility for manufacturing the security devices.

According to another embodiment of the present invention, the production facility manufactures the one or more security devices in response to receiving the order from the computer, where the production facility sends a first confirmation to the computer based on the manufactured security devices being shipped to the first party.

According to another embodiment of the present invention, the first confirmation comprises a shipping date associated with the shipping of the manufactured security devices.

According to another embodiment of the present invention, the first confirmation comprises tracking information associated with the shipping of the manufactured security devices.

According to another embodiment of the present invention, the computer sends a second confirmation to the first party for informing the first party that information associated with the manufactured security devices is stored in a storage device associated with the computer, where the information is stored based on receiving the first confirmation by the computer.

According to another embodiment of the present invention, the computer receives one or more reports from the first party based on the manufactured security devices.

According to another embodiment of the present invention, the bar code comprises a reduced space symbology (RSS) bar code.

According to another embodiment of the present invention, a method of facilitating the authentication of a product is provided by associating a security device with a product, where the security device comprises an optically variable device contained within a carrier associated with a substrate. A bar code is rendered in the optically variable device, where a serialized human readable symbol is provided on a surface associated with the substrate. First data is stored in a storage device, where the first data includes data encoded in the bar code. Second data associated with the product is stored in the storage device, where the first data is associated with the second data in the storage device.

According to another embodiment of the present invention, storing the first data validates the security device.

According to another embodiment of the present invention, accessing the storage using the serialized human readable symbol obtains information usable to authenticate the product.

According to another embodiment of the present invention, the information usable to authenticate the product is based on the stored first and second data.

According to another embodiment of the present invention, the information usable to authenticate the product comprises information associated with an entity to which the security device was sold.

According to another embodiment of the present invention, the information usable to authenticate the product comprises information associated with a type of product for which the security devices were purchased.

According to another embodiment of the present invention, the information usable to authenticate the product comprises the serialized human readable symbol.

According to another embodiment of the present invention, the storage device comprises one or more databases.

According to another embodiment of the present invention, a method of obtaining information from a security device comprises providing an optically variable device contained within a carrier associated with a substrate, where a bar code is rendered in the optically variable device. A serialized human readable symbol is provided on a surface associated with the substrate. The bar code is read both according to a standard associated with the bar code in order to obtain first data, and according to an algorithm not associated with the standard to obtain second data.

According to another embodiment of the present invention, the bar code comprises a reduced space symbology (RSS) bar code.

According to another embodiment of the present invention, a method of determining the authenticity of a security device comprises providing an optically variable device contained within a carrier associated with a substrate, wherein a bar code is rendered in the optically variable device. A serialized human readable symbol is provided on a surface associated with the substrate. The serialized human readable symbol is received at a computer associated with the security device, where data encoded in the bar code is received at the computer. The computer provides an indication that the security device is authentic if the serialized human readable symbol is related to the data obtained from the bar code based on an algorithm.

According to another embodiment of the present invention, the bar code comprises a reduced space symbology (RSS) bar code.

According to another embodiment of the present invention, a method of authenticating a product comprises providing information to a computer, where the information is based on a security device associated with a product. The security device comprises an optically variable device contained within a carrier associated with a substrate, where a bar code is rendered in the optically variable device. A serialized human readable symbol is provided on a surface associated with the substrate. The computer compares the provided information with information stored in a storage device and provides an indication that the product is authentic if the provided information matches the stored information.

According to another embodiment of the present invention, a system for authenticating a product comprises providing a computer for receiving a request from a first party to license a brand associated with a second party, where the computer forwards the request to the second party. The system also includes one or more security devices each comprising an optically variable device contained within a carrier associated with a substrate, where a bar code is rendered in the optically variable device. A serialized human readable symbol is provided on a surface associated with the substrate. The computer authorizes receipt of the security devices by the first party based on the computer receiving approval of the request by the second party. The computer debits an amount from an account associated with the first party based on the first party receiving the security devices. The computer deposits a first portion of the amount in a first account and a second portion of the amount in a second account, whereby the first account is associated with the second party and the second account is associated with an operator of the computer.

According to another embodiment of the present invention, the system further comprises a storage device in communication with the computer, where the product is authenticated by accessing information associated with the product from the storage device based on the computer receiving the human readable symbol.

According to another embodiment of the present invention, the system further comprises a storage device in communication with the computer, where the product is authenticated by accessing information associated with the product from the storage device based on the computer receiving data associated with scanning the bar code.

According to another embodiment of the present invention, a security device for authenticating a product comprises providing an optically variable device contained within a carrier associated with a substrate, where a bar code comprising first data is rendered in the optically variable device. A serialized human readable symbol is provided on a surface associated with the substrate, where the human readable symbol comprises second data. A user authenticates the product by accessing information associated with the authenticity of the product based on the human readable symbol and the bar code.

According to another embodiment of the present invention, the information associated with the authenticity of the product comprises a serial number associated with the product.

According to another embodiment of the present invention, the serialized human readable symbol comprises a serialized number associated with the security device.

According to another embodiment of the present invention, a system for authenticating a product comprises providing a security device including an optically variable device contained within a carrier associated with a substrate, where a bar code comprising data is rendered in the optically variable device. A serialized human readable symbol is provided on a surface associated with the substrate. A computer associated with the security device receives the serialized human readable symbol and the data. The computer provides an indication that the security device is authentic if the serialized human readable symbol is related to the data obtained from the bar code based on an algorithm.

According to another embodiment of the present invention, a security device for authenticating a product comprises providing an optically variable device contained within a carrier associated with a substrate, where a bar code is rendered in the optically variable device. A serialized human readable symbol is provided on a surface associated with the substrate. The bar code is read both according to a standard associated with the bar code to obtain first data, and according to an algorithm not associated with the standard to obtain second data.

According to another embodiment of the present invention, a system for authenticating a product comprises one or more security devices comprising an optically variable device contained within a carrier associated with a substrate, where a bar code is rendered in the optically variable device. A serialized human readable symbol is provided on a surface associated with the substrate. A computer receives information based on the security device associated with a product, where the computer compares the received information with information stored in a storage device, whereby the computer provides an indication that the product is authentic if the provided information matches the stored information.

### BRIEF DISCRIPTION OF DRAWINGS

The invention is illustrated in the figures of the accompanying drawings, which are meant to be exemplary and not limiting, and in which like references are intended to refer to like or corresponding parts.

FIG. 1 illustrates the functional process steps of a Supply Chain Security Management (SCSM) system according to an embodiment of the present invention;

FIG. 2 illustrates a Certificate of Authenticity (COA) ordering process within the SCSM System according to an embodiment of the present invention;

FIG. 3 illustrates a fulfillment function of the SCSM system according to an embodiment of the present invention;

FIG. 4 illustrates an inventory reconciliation function of the SCSM system according to an embodiment of the present invention;

FIG. 5 is an example of a carrier containing an OVD (e.g., a DOVI) including a holographic image of a barcode, according to an embodiment of the present invention;

FIG. 6 is an example of a barcode according to an embodiment of the present invention;

FIG. 7 is a top view a bar of a barcode according to an embodiment of the invention;

FIG. 8 is a side view a bar of a barcode according to an embodiment of the invention;

FIG. 9 is an example of a barcode a portion of which is rendered in a hologram and a portion of which is provided through non-holographic means according to an embodiment of the present invention; and

FIG. 10 is another example of a barcode a portion of which is rendered in a hologram and a portion of which is provided through non-holographic means according to one embodiment of the invention.

### DETAILED DESCRIPTION

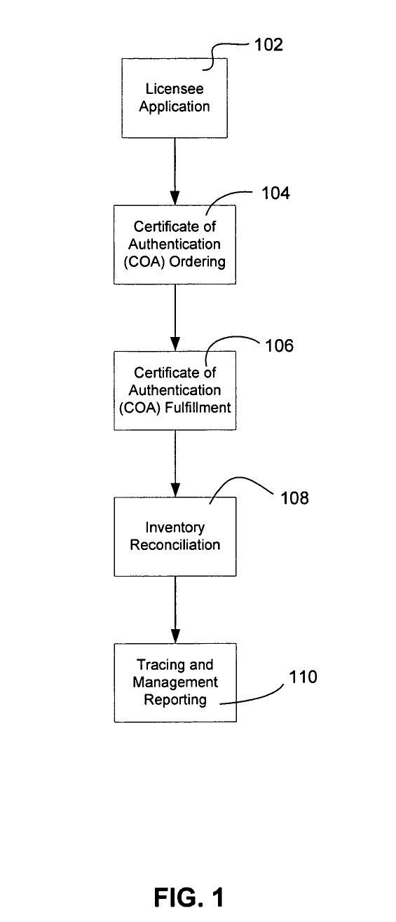

FIG. 1 illustrates the each functional process step of the Supply Chain Security Management (SCSM) system according to an embodiment of the present invention. The SCSM system may comprise a computer, such as an information management system for, among other things, processing, managing, and storing data that is exchanged over a communications network between various users (e.g., a licensee, a licensor, a manufacturer, and a retailer). The SCSM system may include a database for providing data storage, an application program running on a computer device (e.g., client/server configuration) for receiving and processing data, and interfacing capabilities (e.g., network interface card) for providing data communication over a network, such as, the Internet). The applicant program and other computer code may be stored in memory of the SCSM system or on computer readable media, such as magnetic or optical disk. When this application program or other computer code is executed, it causes a computer to perform the functionality described below. The SCSM system's functional steps comprise an online licensee application step 102, COA ordering step 104, COA fulfillment step 106, inventory reconciliation step 108, and tracing and management reporting step 110. The online licensee application step 102 enables a potential sponsor to apply online and have all of the required application information forwarded to a Brand Owner for review and possible approval. The COA ordering step 104 creates and adjusts orders for each licensee in accordance with defined business rules. The COA fulfillment 106 facilitates the picking and delivery of the correct quantity of COA's to meet the production needs of each licensee. The inventory reconciliation step 108 carefully ties the order quantity, the delivery to licensees, and the actual consumption of COA's as part of shipped licensees' finished goods. The step of tracing and management reporting 110 provides factory distributor and brand owner users with critical data to ensure the effective ordering and fulfillment of COA's. This function includes the determination, using a COA serial number, of which licensee the COA was sold to, when, and for what kind of product.

The online licensee application function 102 of the SCSM system may be configured to allow potential licensees of the Brand Owner to access and input data into all of the required forms needed for the Brand Owner to consider approving the potential licensee. Based on the Brand Owner's requirements, any documentation and application package may be put on the Brand Owner's website for collection of data. The data may then be forwarded to the appropriate personnel at the Brand Owner establishment for review and approval.

The COA ordering function 104 supports the creation and adjustment of COA orders for licensee factories, in accordance with defined business rules. For example, the SCSM system may support two methods for creating orders: (1) automatic order creation and/or (2) order entry by licensee. In the automatic order creation method, orders are automatically generated when a licensee's finished goods are produced (may be called the “PUSH” method). For example, a notification of completed goods or products may be sent from the licensee's factory or manufacturing facility to the SCSM system's application program running on a remote server. Communication between the SCSM system and the licensee's facility may, for example, be governed by Internet protocols (e.g., TCP/IP) or other suitable communication systems and protocols. In the other method for creating COA orders, order entry may be performed by licensees, where licensees may be required to provide identity verification in accordance with pre-established rules (may be called the “PULL method”).

In addition to supporting both the PUSH and PULL methodologies for controlling ordered quantities of COA's, the SCSM system may also provide additional functionalities related to ordering. These functionalities may comprise “order confirmation,” which may be managed by e-mail communication to the licensee for confirming order number, items ordered, quantities ordered, expected shipment date, and/or price; “order adjustments and changes,” whereby within a certain time period after the initial posting of the order, licensees may log into the SCSM system to request adjustments to order quantity, merchandise type, and/or the date of shipment; “order status,” where licensees may review information stored for open and closed orders, such as status, expected shipping dates, quantities and prices, etc. The Brand Owner may also review all of this data at any time.

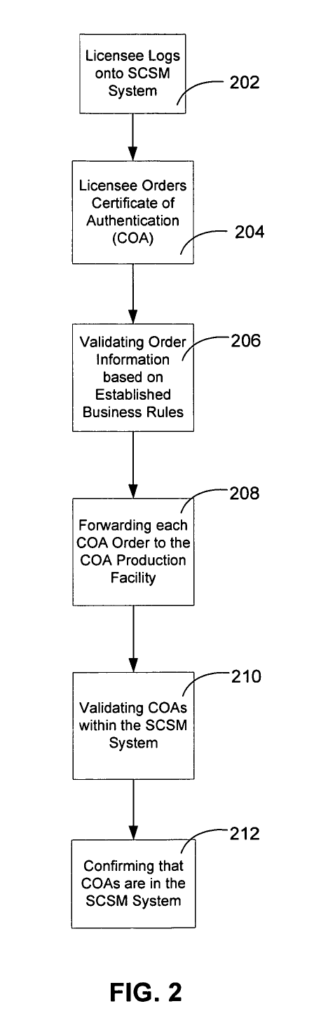

FIG. 2 illustrates the COA ordering process of the SCSM System according to an embodiment of the present invention. At step 202, the licensee or its authorized factory, logs onto the SCSM System through, for example, a network such as the Internet, using a secure user ID and password. At step 204, the licensee/Factory may order COA's by entering order information into an order screen. Examples of entered order information may include type of COA needed, product or product family to which the COA will be applied (the licensee or authorized factory may select only from those products they are authorized to sell), order quantity, and requested receipt date. At step 206 data is validated against the established business rules defined for each licensee (e.g., if the licensee is limited/authorized to order only a certain quantity of COA's). At step 208, the SCSM system forwards each order to the COA production facility where the COA's will be produced. At step 210, if desired, as a condition to the COA's being recognized as valid when scanned into the system at some further point in the supply chain (e.g., at retail point of sale), a user at the production facility must log onto the SCSM system and enter the confirmed orders shipped, including shipping date, applicable taxes and other surcharges. This may be done, for example, after each production run, or periodically (e.g., every night). At step 212, once confirmed, the SCSM system sends a confirmation notice (e.g., e-mail) to the licensee, informing the licensee that the COA's associated with a particular order is now in the system. Licensees are able to log into the SCSM system at any time to review or generate reports on all orders associated with the issuance of authorized COA's that are associated with the licensee's organization.

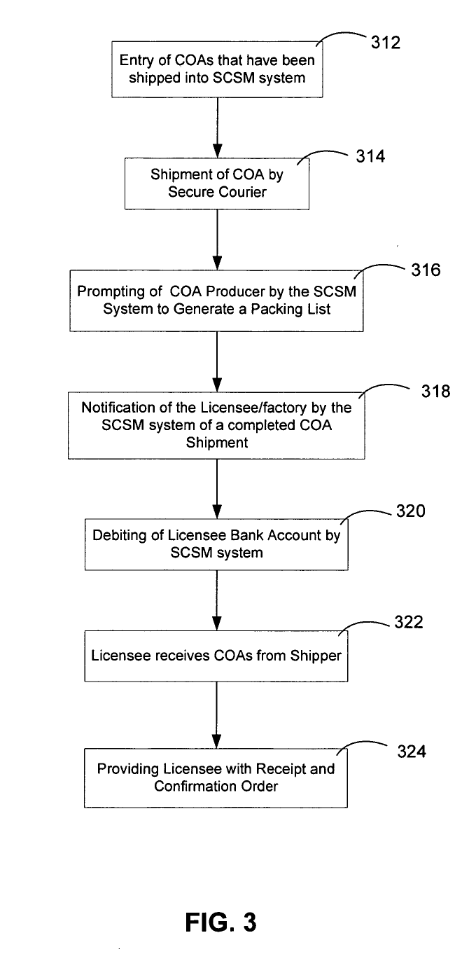

FIG. 3 illustrates the fulfillment function of the SCSM system according to an embodiment of the present invention. The fulfillment function includes the process of delivering COA's to the licensee. This function is managed by the SCSM system in a secure and auditable manner. Elements of the fulfillment function may comprise the generation of lists from which to pick COA's (“pick lists”), which enables the COA producer to identify various COA products to be picked and prepared for shipment to the licensee that placed the order; capture of serial numbers shipped, which captures the specific serial numbers that are included in each order to a licensee; generation of packing slips and invoices for shipment, based on the SCSM system supporting the creation of the appropriate paperwork to be included in each shipment (layouts and data may be configured to fit each situation); capture of shipment tracking information, where the COA producer defines information for tracking and notification purposes. This information may include, for example, quantity shipped, carrier, carrier's tracking number, etc.

Other functionality associated with the fulfillment function may include shipment notification, which is typically provided by e-mail to the licensee, confirming order number, items ordered, quantities ordered, expected shipment date, and other data required when receiving the COA's at their location and posting it in the SCSM System. If desired, COA's may not be valid until the licensee logs (e.g., stores for later reference) information for the completed product and its corresponding COA (e.g., serial numbers for the product and corresponding COA) into the SCSM system.

According to one embodiment of the invention, the fulfillment process carried out by the SCSM system is indicated by the steps shown in FIG. 3, where at step 312, daily (or with other frequency, as needed), each COA producer location enters into the SCSM system the COA's that have been shipped, thus initiating the chain of custody. The entry into the SCSM system may include the quantity of COA's shipped and the shipment tracking information (e.g., name of the carrier and tracking number). At step 314, the COA may be shipped by secure signature courier, while, at step 316, the SCSM system prompts the COA producer to generate a packing list. At step 318, the SCSM system sends an e-mail or notice to the licensee, notifying them of a completed COA shipment, expected delivery date, and shipment tracking information. At step 320, the SCSM system automatically automatically causes a debit from the licensee bank account based on the licensing fee and and credits to two accounts. First, a credit for the royalty fee goes to the account of the Brand Owner. Only the Brand Owner has access or control of this account. The SCSM system may only transfer money into this account. Secondly, a credit for the COA fee goes to the SCSM system. The SCSM causes this electronic transfer of funds based on techniques and methods known in the art. There are no refunds to licensees. At step 322, the licensee/factory receives (or picks up) COA's from shipper. No billing occurs to licensee. At step 324, a receipt is available to print on licensee's computer and a receipt is emailed with the order confirmation.

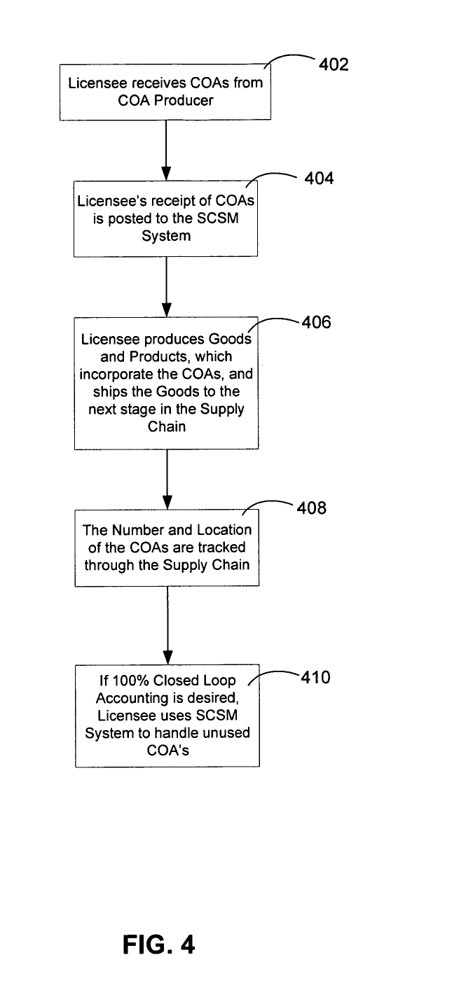

FIG. 4 illustrates the inventory reconciliation function of the SCSM system according to an embodiment of the present invention. The inventory reconciliation process provides a security mechanism to monitor the actual numbers of COA's in the system and providing a continual oversight of the chain of custody based on whether the COA's are placed on the goods or unattached. Functionality that support this process comprises receipt confirmation, either via automatic data feed from common carrier systems or via acceptance/receipt confirmation directly in the SCSM system. As previously mentioned, only after COA's are logged (e.g., stored for later reference) into the SCSM system are they recognizable as valid.

Other functionality of the reconciliation process includes inventory status management, where orders for COA's are tracked through the supply chain and managed carefully in one of the inventory categories, such as, COA producer inventory; shipped/in-transit; at licensee/factory; on completed, registered product.

The functionality also includes an order lifetime management process. During this process, as COA's go through a lifecycle of order placement, shipment, application to product, and finished goods shipment, the SCSM system reconciles the quantity in each of these stages to ensure no “leakage.” When quantities match in each stage, the order is “closed” and archived.

Another functional process comprises unallocated Inventory, which manages the “extra” COA's shipped to a licensee (over orders are standard practice to make up for defective or damaged COA's). The SCSM system tracks unallocated COA's and ensures that subsequent orders first deplete the COA's on hand before shipping additional COA's.

The scrap inventory functional process controls the identification, reporting and authorized destruction of scrap COA's, and the reasons for scrapping the COA's in order to ensure system knowledge of COA's that are consumed, but not applied to a legitimate finished product.

According to the embodiment illustrated in FIG. 4, the SCSM system carries out the inventory reconciliation process in several steps. At step 402, the licensee/factory may receive COA's from a COA producer for use in production. At step 404, the licensee's/factories receipt of the COA's may be posted to the SCSM system to indicate that the secure items are now in the licensee's/factory inventory and no longer in-transit (automatic feed from UPS, FedEx, etc., may also be used to confirm licensee receipt of shipment, and acceptance of quantity). At step 406, the licensee/factory may produce goods and products (which incorporate the COA's) and then ships the finished goods to the next stage of the supply chain (i.e., Licensees, customers or others). At step 408, the number and location of the COA's may be tracked through the supply chain by the “pack and ship” modules, described below, to “close the loop” on licensee orders and inventory (i.e., to account for all used and unused COA's)

At step 410, if 100% closed loop accounting is desired, the SCSM System accounts for, and handles, COA's that are not in use (e.g., not applied to a particular product). For example, licensees may log all scrap COA's (and the reason for scrapping COA) into the SCSM system, thereby “de-commissioning” that COA ID from legitimate use. Licensees may also, for example, use the SCSM system to mark scrap COA as physically destroyed in their presence. All scrapped COA are marked invalid in the system.

Through the tracing and management reporting function of the SCSM system, users have access to a wide variety of reports and information to manage the ordering and fulfillment of COA'S. For example, the online look-up (“tracing”) of individual COA's. Authorized users may enter a particular serial number and determine, among other things, to whom the COA was sold (e.g., shipping date and order number); for which product type the COA was purchased; the destination (and date of delivery) of the serialized finished product, if applicable, specific product details such as product SKU, color, and size; and public inquiry capability for determining the authenticity of COA and product it came with. Thus, a party downstream in the supply chain (e.g., a retailer) may be able to determine authenticity of a product based on time and location information retrieved from the SCSM system. For example, if a retailer in New York received a shipment of branded products on a given day, but the SCSM system provides information stating that the COAs corresponding to those products (e.g., based on product and COA serial numbers) were to have arrived in California on that day, the products may be stolen or counterfeit.

Through pre-defined and dynamically generated reports, users may see and print whatever up-to-date information is required to order, pick/ship, apply and pay for COA's. Samples of data available to authorized users may include, for example, summary order and shipment statistics; COA Factory inventory status and usage, whether in-transit, at factories and/or consumed; inventory usage and reconciliation; tracing the shipment destinations (for serialized COA); COA scrap management; detailed views of order data that may be findable and sortable by licensee, product, date, and purchase order number; open and closed orders; pending and completed shipments (and the orders within each shipment); and data available via look-up online, or by generating reports.

According to an embodiment of the present invention, the COA's used may combine and utilize holographic technology, overt and covert embedded security technology, and bar code symbology, such as RSS bar code technology. The use of an RSS bar code, and/or other bar code symbology in a hologram may, for example, significantly reduce the ability to fraudulently reproduce the COA's. In addition, the RSS bar code in a hologram may be used in maintaining the supply, chain of custody of the data mentioned above, which may further reduce the chance of counterfeit COA's.

RSS bar codes are also compatible with existing bar code standards in over 140 countries and a recognized standard in the UCC/EAN family of bar codes. In addition, the use of RSS bar code symbology means that standard off-the-shelf-scanners worldwide will be able to read the information throughout the supply chain.

The SCSM system technology and architecture according to an embodiment of the present invention may provide architectural principles, such as high-performance (light-weight transactions); robustness (able to handle faults/errors); cross-platform (O/S, DB, TP monitor); configurable (routing & business rules, batch configuration); distributed; extensible (SDK/API, ODBC/SQL, XML); layered (to improve quality, portability, robustness); and easy to integrate new devices. High-performance may be enabled through the use of a lightweight transaction infrastructure that ensures that messages are reliably delivered to applications with minimal overhead. The use of queues, distributed services, error notification and industrial-strength databases may provide, among other capabilities, a robust and uninterrupted operation.

According to an embodiment of the invention, the SCSM System is implemented with a four-layer architecture comprising devices, a platform, modules, and external applications.

Devices may include input (e.g., bar code scanners, optical readers, data entry pads, RFID readers), output (e.g., printers/coders/markers, RFID writers, displays) and controls (e.g., Programmable Logic Controller “PLC” interfaces).

The platform may comprise a distributed application framework, which may include functions, such as, data management, transaction management & routing, rules management, user (role) management, network (node & message) routing, query & report, and user interfaces.

According to an embodiment of the present invention, the data management function enables the SCSM system to utilize one or more object databases and/or other data storage devices to manage its internal data, including rules and configurations. For example, it may utilize an SQL-compliant relational database for the storage of real-time transactional data. The SCSM System may support some databases, such as, Oracle and SQL Server, natively, and support other major relational databases through widely available ODBC adapters.

According to an embodiment of the present invention, the transaction management & routing function of the SCSM System may provide a reliable high-speed lightweight transaction mechanism for routing messages among devices, modules, and servers. It implements queue management with guaranteed delivery of messages.

According to an embodiment of the present invention, rules govern the behavior of the SCSM system (rules management function). Rules may be entered via a graphical user interface (or textually) and are stored within an object database of the SCSM system. They may be used within each module to enforce constraints (e.g., how many items are to be placed in a case, or what to do on a misread or misprint) and accomplish actions (send an Advanced Shipping Notice (ASN), or notify a system operator).

According to an embodiment of the present invention, each user may be authenticated by the SCSM system and subsequently authorized to use certain aspects of the system (user management function). Users are assigned to “Roles” that give them specific authorizations (e.g., Packer, Shipper, and Line Supervisor).

In the network routing function, according to an embodiment of the invention, the SCSM system may provide the mechanism to define the network configuration and routing of the SCSM system components (e.g., servers, workstations, readers and scanners, printers, PLC interfaces and interfaces to external systems). Messages may be routed based on their source, timing and/or content.

According to an embodiment of the present invention, the SCSM system may provide a toolkit for generating custom inquiries and reports (query & reporting function). Certain inquiries and reports may be predefined for the use (e.g., the most important and common inquiries and reports associated with supply chain tracking and tracing).

According to an embodiment of the invention, the SCSM system may include a user interface that is a graphical user interface utilizing an industry standard look-and-feel (user interface function). The end-user modules may be provided as stand-alone applications on workstations or as HTML-based web pages. In addition, a subset of the functionality may be available, for example, on mobile devices such as PDA's, mobile phones, and handheld computers.

According to an embodiment of the present invention, modules are applications built upon the platform, which provide the specific end-user visible functionality.

According to an embodiment of the present invention, the SCSM system may include a set of API's and utilities allowing integration with enterprise applications, such as, enterprise resource planning (ERP), warehouse management (WMS), supply chain optimization and system operation.

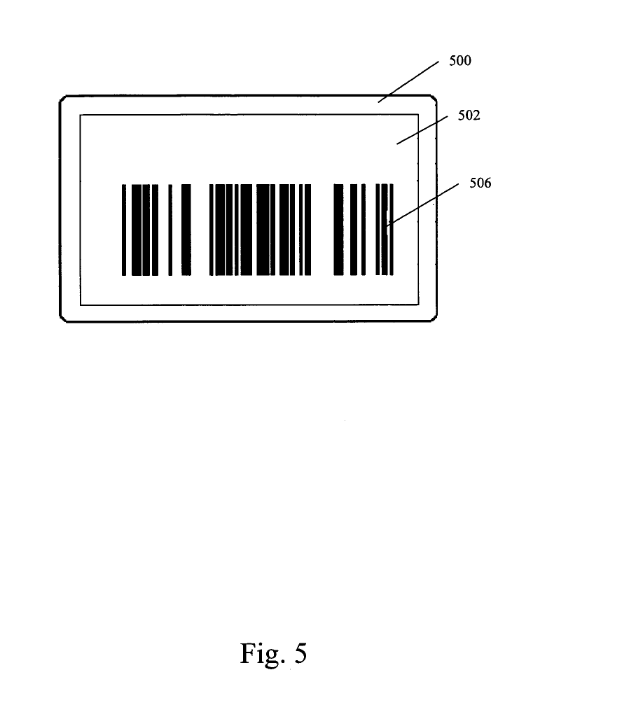

The COAs may comprise a machine-readable symbol, such as a bar code, rendered in an optically variable device (OVD), such as a diffractive optical variable image. The term “diffractive optical variable image” as used herein may refer to any type of holograms including, for example, but not limited to a multiple plane hologram (e.g., a 2-dimensional hologram or a 3-dimensional hologram), a stereogram, and a grating image (e.g., dot-matrix, pixelgram, exelgram, and kinegram). The following paragraphs below discussing FIGS. 5-10 describe the incorporation of a bar code within an OVD according to embodiments of the present invention.

In FIG. 5, according to one embodiment of the invention, an optically variable device (OVD), such as a DOVI, is contained within a carrier 502. The carrier 502 may be any object capable of holding an OVD or a DOVI, such as, for example, a photographic plate or a plastic label. The OVD contained within the carrier 502 includes a holographic image 506 of a bar code. The carrier 502 may be affixed to a substrate 500, which may be any object or surface of an object onto which a carrier may be affixed, such as, for example, a plastic card (e.g., an identification card, a credit or debit card, or a product tag), a metal surface, or the surface of a container. The carrier 502 may be affixed to the substrate 500 through a variety of techniques, such as, for example, by using an adhesive or by laminating the carrier 502 to the substrate 500.

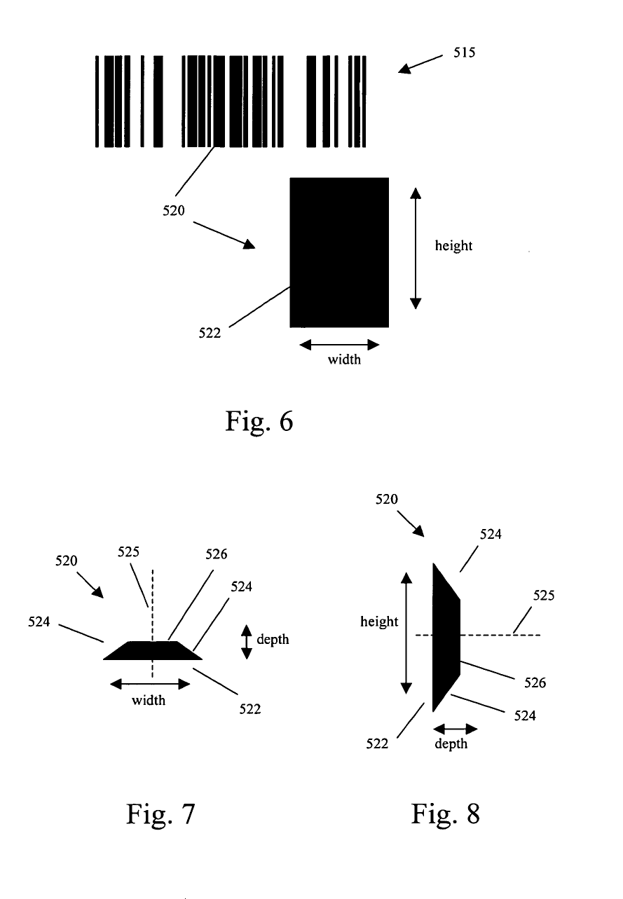

The holographic image 506 (FIG. 5.) is a holographic rendering of a bar code 515, shown in FIG. 6. Bar code 515 may be a two-dimensional bar code in which case the holographic image 506 rendered from it will not have a parallax effect when viewed from different angles. To be capable of being rendered as a holographic image with such a parallax effect, if so desired, bar code 515 must be given depth so that if bar code 515 were a linear bar code it would appear as a picket fence with each bar 520 appearing as a slat of the fence. The holographic image 506 of bar code 515 may be created through known techniques. For example, bar code 515 may be created as an electronic image which is then rendered as holographic image 506 through known digital holographic techniques.

To maximize the readability of a holographic image 506 of a bar code 515 (e.g., the ability of the holographic image to be accurately read by a bar code scanner to thereby obtain the information encoded in the bar code rendered in the hologram), certain characteristics of the bar code and the holographic image rendered from the bar code may be manipulated. For example, as is known in the art, contrast between bars and spaces and edge quality are two characteristics of bar codes that determine their readability. With regard to contrast, colors may be chosen for the bars and spaces of the bar code 515 (e.g., black, cyan, or blue for bars and white, red, or yellow for spaces) so that when bar code 515 is rendered into holographic image 506, there is at least a 50% difference in contrast between the bars and spaces in the holographic image 506 of the bar code. For example, a black color known as “Optical Black” offered by Applied Optical Technologies, Inc. may be used for the bars.

With regard to edge quality, several techniques may be used to improve this characteristic of the holographic rendering 506 of bar code 515. For example, the depth of each bar 520 of bar code 515 may be kept very small compared with either the width or height of the bar. For example, the depth may be kept to half the size of the width or less. This will increase the sharpness of the edges of holographic image 506 rendered from bar code 515 and thereby increase the readability of the holographically rendered bar code.

Another way to increase the edge quality of the holographic rendering 506 of bar code 515 would be to give bar code 515 tapered side-walls. Referring again to FIG. 6, an exemplary bar 520 of bar code 515 is expanded to show the front side 522 (e.g., the side normally read by a scanner) of the bar. FIGS. 7 and 8 present top and side views, respectively, of bar 520 and show the rear side 526 and side walls 524 of bar 520. It should be noted that FIGS. 7 and 8 are not drawn to scale. As shown in FIGS. 7 and 8, the side walls 524 are tapered toward a central axis 525 of bar 520. Tapering the side-walls of bar code 515 in the manner described above increases the sharpness of the edges of holographic image 506 rendered from bar code 515 which, in turn, increases the edge quality and readability of the holographic rendering 506 of bar code 515.

In another embodiment, different colors may be used increase the readability of the holographic rendering 506. For example, if a color not typically readable by bar code scanners (e.g., white, red, and yellow) is chosen for the sidewalls of bar code 515 and a different unreadable color used for the background, then, in the holographic rendering 506, the sidewalls would be viewable, e.g., by a human observer, but would not be scannable by a bar code scanner. Thus, bar code 515 could have bars with sidewalls greater than half their width and the holographic rendering 506 could still be accurately scanned as a bar code.

Although in the figures discussed above bar code 515 is shown as a linear bar code, it should be understood that bar code 515 may include other machine readable indicia including, for example, two-dimensional bar codes and composite bar codes, e.g., RSS bar codes.

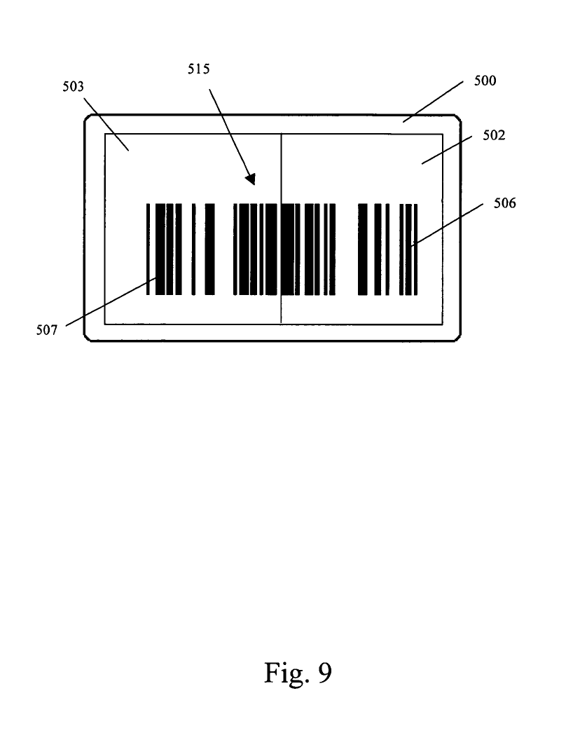

The bar code 515 may be used to encode a variety of information. For example, where carrier 502 and substrate 500 are a plastic product identification label affixed to plastic tag, respectively, bar code 515, of which image 506 is a holographic rendering, may encode the GTIN (Global Trade Identification Number) of the product to which the product ID label is to be attached. For information purposes, the GTIN consists of a packaging identifier, manufacturing number, product number and check digit. It conforms to the numbering system set up by the Uniform Code Council and the European Article Numbering Association. Holographic bar code 515 may, for example, be incorporated in a certificate of authenticity (COA), where substrate 500 may be formed by the COA. Information associated with product to be authenticated may be encoded into the bar code. For example, the encoded information may include a serial number that is related to the COA to which the bar code is attached. The COA may also comprise a human readable serial number that is related to the encoded serial number in the holographic bar code. The human readable serial number may be formed on substrate 500 or on carrier 502. The human readable serial number may also be located in proximity to, or placed over, the holographic bar code (e.g., bar code 506, FIG. 9). The encoded serial number and human readable serial number may be related by a mathematical function or algorithm. This restricts the counterfeiting of COAs, since the counterfeiter does not know the relationship between the human readable serial number and the encoded serial number in the bar code. This provides an additional anti-counterfeiting measure to the utilization of holographic techniques to generate bar code symbology.

Product ID labels containing OVDs (e.g., DOVIs) that include holographic images of bar codes provide benefits including enhanced authentication properties. For example, without the use of bar codes, a product ID label may contain an OVD (e.g., a DOVI) that includes an image of a symbol related to or a trademark of the product manufacturer. A counterfeiter able to duplicate the label could place it on any products and then pass off those products as being from the manufacturer. However, for a product ID label with an OVD (e.g., a DOVI) including a holographic image of a bar code that encodes a GTIN corresponding to a particular product, even if a counterfeiter were able to duplicate the label, the bogus label could only be used with products corresponding to the encoded GTIN or risk easy detection.

According to another embodiment of the invention, the holographic image 506 of bar code 515 may be formed so that the image 506 is only visible at a certain angle or range of angles. One way in which this may achieved is through the three-dimensional appearance of holographic image 506. For example, as is known, certain bar code formats require bars of a bar code to be a certain width in order for the bar code to be properly scanned. Then, where bar code 515 is three-dimensional, the dimensions of the bars could be chosen so that the holographic image 506 rendered from bar code 515 would be scannable only at a certain angles. For instance, assume a given bar code format requires a bar width of 1⅛ inches. The bars of bar code 515 could be given a width of 1 inch with sidewalls of 1/4 inch and where the sidewalls are of a color typically recognized by bar code scanners (e.g., blue or black). Consequently, a holographic image 506 rendered from bar code 515 when viewed at no angle, e.g., so that only the front side is viewable, would present a width of 1 inch and would not be scannable. However, when holographic image 506 is viewed at an angle equal to or greater than a certain angle, enough of the sidewall is viewable so that the viewable width of the front side plus the viewable sidewall would present a total of 1⅛ inches or more and the image 506 would thus be scannable.

Alternatively, or in addition, the holographic image 506 of bar code 515 may be formed so that the image 506 is only visible at a certain wavelength or range of wavelengths of light. Conversely, the holographic image 506 of bar code 515 may be formed so that the image 506 disappears at one or a range of predetermined angles or wavelengths. Such features provide benefits including enhanced security and authentication properties since the angle(s) or wavelength(s) at which the holographic image 506 of bar code 515 should be detected or should not be detected may be predetermined and shared only with authorized personnel.

FIG. 9 shows another embodiment of the invention in which a bar code is partially rendered in a holographic image and partially provided through other known means, such as thermal or ink printing or laser etching. A bar code 515, e.g., a linear bar code, may be split into two portions with one portion rendered into a holographic image 506 contained in a carrier 502 that is then affixed to a substrate 500, as described above. On an area 503 abutting the carrier 502, the other portion 507 of the bar code 515 may be provided by other means as mentioned above. The area 503 may include any surface onto which a bar code may be created. For example, area 503 may be formed from part of carrier 502. One portion of carrier 502 may include the holographic image 506 and the other portion may be sprayed with ink of a color suitable for the background of a bar code, e.g., white, red, or yellow. Alternatively, area 503 may be a paper label of a suitable background color affixed to substrate 500. Also, area 503 may be substrate 500 itself.

In this embodiment, the carrier 502 including the holographic image 506 of a portion of bar code 515 may be produced and affixed to substrate 500 in a first step. Area 503 may be formed at the same time as carrier 502 (e.g., where area 503 is the substrate 500 or a portion of carrier 502) or may be added later (e.g., where area 503 is a paper label). At a later time, the remaining portion 507 of bar code 515 may provided onto area 503, e.g., printed or etched. Where etching is used, area 503 may include a first layer suitable to form the bars of a bar code over a second layer suitable for the background of a bar code. A suitable tool, e.g., a laser, is then used to etch the spaces of the portion of bar code 515 from the first layer of area 503.

For efficiency of cost and time, it may be desirable to produce the carrier 502 including holographic image 506 in large quantities with each portion of bar code 515 contained therein being identical. However, since the remaining portion of bar code 515 is provided later through less costly and time intensive non-holographic means, the remaining portion of bar code 515 may be used to encode additional information available only after the creation of the carriers 502 including the holographic images 506.

For example, bar code 515 could be a linear bar code format having a user definable portion, such as Code 39. The non-user definable portion could be used to encode information likely not to change, e.g., the name of a performer on tour, and this non-user definable portion could be rendered as the holographic images 506 contained in carriers 502. The user definable portion of the bar code could be used to encode information likely to change, e.g., the times and venues of particular performances on the tour. This changing information could be provided on the areas 503 later as needed, e.g., a week before a particular performance.

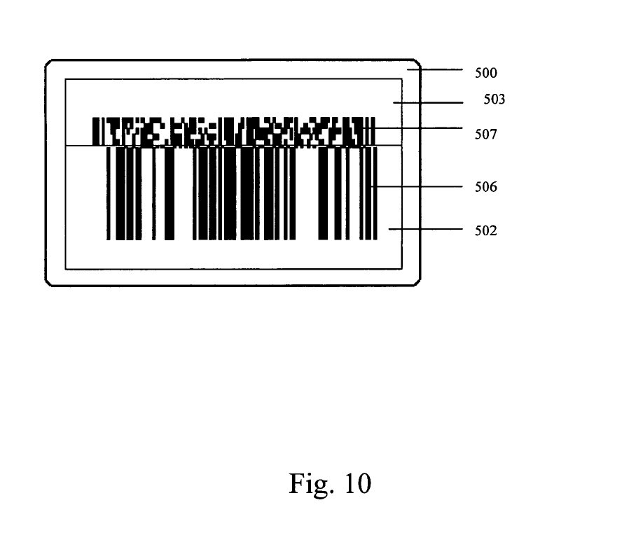

In the embodiment of the invention where a bar code 515 has one portion rendered as a holographic image and another portion provided through non-holographic means, bar code 515 may also comprise a two-dimensional bar code or a composite RSS bar code as shown in FIG. 10. As described above, a portion of the RSS bar code 515 is rendered in a holographic image 506 contained in a carrier 502 and the remaining portion 507 is provided onto area 503 through non-holographic means. In the example shown in FIG. 10, the linear portion of RSS bar code 515 is rendered as the holographic image 506 while the remaining portion 507 to be provided onto area 503 through non-holographic means is the two-dimensional portion of RSS bar code 515. Also, a space may be provided between the two portions 506 and 507 to help reduce scanning errors.

RSS has twelve different formats, each of which may consist of a linear portion with a two-dimensional composite code printed above which can hold an additional portion of data; up to 2300 additional characters of information. In the RSS-14, RSS Limited, RSS Stacked, RSS Omni-directional, RSS Truncated, UPC, Code 128 or EAN bar code may be used as the linear lower portion of the RSS bar code to encode the GTIN (Global Trade Identification Number) plus linkage characters which alert the scanners to the fact that another portion of the bar code, the two-dimensional portion, exists and the scanner will seek out that additional information before finishing reading.

As mentioned above in connection with FIG. 9, the portion 507 of RSS bar code 515 may encode additional information available only after the holographic images 506 and carriers 502 are produced. For example, one piece of additional information that can be added to the GTIN product number (that may be encoded in holographic image 506) is the time and place of manufacture. Another example might include a unique serial number, individual product identifier, or secret code which is a derivative of the other information on the label. In so doing, the time that a counterfeiter has to replicate the label is now reduced to a measurable window of time, for if the label which says that the time of manufacture was ‘A’ and the expected use of such an object is one week, then a label arriving with a printed time of manufacture would either fit into the supply chain scheme or not for only one week. The same could be said for place of manufacture or point of distribution or the like. Further, the encryption of this information adds another layer of security to the authenticity of the label in that it would be so much more difficult to counterfeit the label if one not only had to reproduce the manufacturing process of the label but also needed to know the encryption algorithms. Further, such encryption algorithms could change periodically throughout the manufacturing process.

It should be noted that when the remaining portion 507 of bar code 515 (linear, two-dimensional, or RSS) is provided onto area 503 and substrate 500, the remaining portion 507 must align properly with the other portion rendered as holographic image 506 so that the combined portions 506 and 507 can be scanned correctly as a bar code. Also, the bar code characteristics (e.g., wide narrow ratio, edge quality, X dimension, contrast, and bar width reduction) of each portion 506 and 507 must be conserved so that the combined portions 506 and 507 scan correctly as a single bar code.

According to another embodiment of the invention, a manufacturing method is provided for creating a plurality of unique holographic images. A plate large enough to accommodate a plurality of holographic images is used. A plurality of unique holographic images are then recorded onto the plate. For example, the images may include a series of human readable numbers, e.g., 1-400, or a series of unique bar codes encoding a series of numbers. Once the plurality of images is recorded onto the plate, the plate is used to mass produce groups of carriers 502 with the holographic images. Thus, groups of carriers 502 may be produced in mass from the plate where, within each group, the holographic images are unique.

During packaging, groups of carriers 502 having a particular sequence (e.g., 1-50, 37-57, or 264-284) are likely to be packed in the same container. Consequently, counterfeiting activity could be easily detected where all or many of the carriers 502 contained in a package carried the same number rather than sequential numbers.

RSS bar code Symbology was developed over the past seven years by the UCC/EAN organizations in an effort to better serve the bar code user community in the UCC/EAN 140 member countries. The user community in these 140 countries represents virtually all companies selling merchandize throughout the world. The user community of companies currently uses UPC (Uniform Product Code) in the United States and Canada, and, EAN (European Article Numbering System) throughout the rest of the world. The advantages of the RSS bar code paradigm is that it solves two immediate problems, such as, firstly, bar codes have been too big, taking up too much space on packaging and therefore not being able to be used on small containers. Secondly, they were only able to hold a very limited amount of information. The smallest RSS bar code is just 12 mm wide. An RSS bar code may theoretically hold over 2300+ characters.

According to an embodiment of the invention, RSS bar codes may be used to enable the creation of machine-readable encryption of the hologram element. However, it should be noted that any type of bar code may be used. RSS bar codes provide several advantages, such as, being supported by the largest, most popular and widely used numbering system in the world for general merchandize, retail, pharmaceuticals, food, clothing, jewelry, books and magazines. Any items encoded with RSS may be able to be scanned by the same scanners as are being deployed now in retail checkout scanning (e.g., over the last 3 to 4 years almost all generally available scanners produced by the major manufacturers are either off the shelf RSS compatible, or easily made compatible with free online upgrades also available from the manufacturer). RSS is backwardly compatible, whereby it includes twelve different formats. These include RSS UPC and RSS EAN, which are readable by both the older traditional scanners currently in use and the newer RSS scanners. That means that shopkeepers who only have the older scanners may read RSS UPC and RSS EAN. Since RSS bar codes conform to the rules of the UCC/EAN numbering system, they may be used to label merchandise using the same system. The same item numbers, manufacturing numbers, country codes, packaging designators may be used for RSS labeled merchandize. Suppliers and manufacturers may not have to create new numbers for items.

RSS bar codes have rules and guidelines for including human-readables. Most new bar code symbologies that are high-density two-dimensional codes do not have the capacity to include human-readable information as well. We know that in most cases, even when two-dimensional bar codes are used, it is necessary, even important, that human-readable information be printed as well. Also, RSS bar codes use a system called Application Identifiers (“AI's”) to help further encode data. An Application Identifier is an abbreviation that tells a scanner what is encoded in order to save space. For example, instead of encoding “Expiration Date equals Apr. 15, 2004” we would use the AI of (17) which stands for “Expiration Date” and tells the scanner “the next six digits are the expiration date in the form year-year-month-month-day-day”. Therefore, we encode “(17)040415” to indicate the same as that long sentence in just eight (8) characters. AI's are used throughout the world, also closely related to the UCC/EAN numbering system. There are AI's for different kinds of data, such as, documents, weights, measures, dates, addresses, names and so forth. RSS is very small. Some formats of RSS are as small as 12 mm wide.

RSS is printed in two-parts. The first part, we call the linear bar code. It looks like traditional bar codes with vertical bars whose widths and spaces hold the encoded information. The data is strictly numeric. The second part, we call the two-dimensional composite code, is printed above the first linear portion. It contains a variable amount of data and gets taller as more information is added. It may hold alphanumeric information in large quantities. Typically, we may put twenty or more characters of additional information in the two-dimensional composite code. An RSS Limited code with fifty characters is about the size of a thumbnail.

According to an embodiment of the present invention, for example, holograms and an RSS EAN-128 code may be used. However, as mentioned above, any type of bar code may be used and the bar code need may not be in a hologram. The RSS bar code may place a unique number in the OVD that is machine-readable. If desired, additional information may be overprinted outside the OVD using, for example, thermal transfer printing techniques. The overprint may be a ten-digit, randomly serialized identification number that will make each COA unique. The numbers may be selected randomly, making the set going to a particular vendor impossible to duplicate.

RSS EAN-128 may be used so that the merchandise bar code (UPC or EAN) is not confused with the bar code used in the COA bar code in an OVD. Guidelines prohibit having two merchandise bar codes on the same article.

The bar code in an OVD produced for a Brand Owner and used for its licensee's product labels, will flow through the SCSM system with these randomly selected, unique security numbers. These numbers may correspond to both machine-readable and human-readable symbologies.

Biocode, such as, DNA may be “uniquely genetically engineered plant DNA” for use in one brand identity and is then destroyed. The DNA may be applied to the hologram and is forensically detectable to determine authenticity.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modifications are intended to be included within the scope of the invention. Except to the extent necessary or inherent in the processes themselves, no particular order to steps or stages of methods or processes described in this disclosure, including the Figures, is implied. In many cases the order of process steps may be varied without changing the purpose, effect or import of the methods described.

1. A method of licensing a brand, comprising:
receiving, at a computer, a request from a first party to license a brand associated with a second party;
forwarding the request from the computer to the second party;
the computer authorizing the receipt of at least one security device by the first party based on the computer receiving approval of the request by the second party, wherein the security device comprises an optically variable device contained within a carrier associated with a substrate, wherein a bar code is rendered in the optically variable device, wherein a serialized human readable symbol is provided on a surface associated with the substrate;
the computer debiting an amount from an account associated with the first party based on the first party receiving the at least one security device; and
the computer depositing a first portion of the amount in a first account and a second portion of the amount in a second account, wherein the first account is associated with the second party and the second account is associated with an operator of the computer.

2. The method according to claim 1, wherein the computer authorizes the receipt of the at least one security device by submitting an order for the at least one security device to a production facility for manufacturing the at least one security device.

3. The method according to claim 2, comprising:
the production facility manufacturing the at least on security device in response to receiving the order from the computer;
the production facility sending a first confirmation to the computer based on the manufactured at least one security device being shipped to the first party.

4. The method according to claim 3, wherein the first confirmation comprises a shipping date associated with the shipping of the manufactured at least one security device.

5. The method according to claim 3, wherein the first confirmation comprises tracking information associated with the shipping of the manufactured at least one security device.

6. The method according to claim 3, wherein the computer sends a second confirmation to the first party for informing the first party that information associated with the manufactured at least one security device is stored in a storage device associated with the computer, and wherein the information is stored based on receiving the first confirmation by the computer.

7. The method according to claim 6, wherein the computer receives one or more reports from the first party based on the manufactured at least one security device.

8. The method according to claim 1, wherein the bar code comprises a reduced space symbology (RSS) bar code.

9. A method of facilitating the authentication of a product, comprising:
associating a security device with a product, wherein the security device comprises an optically variable device contained within a carrier associated with a substrate, wherein a bar code is rendered in the optically variable device, wherein a serialized human readable symbol is provided on a surface associated with the substrate;
storing first data in a storage device, wherein the first data includes data encoded in the bar code; and
storing second data associated with the product into the storage device, wherein the first data is associated with the second data in the storage device.

10. The method according to claim 9, wherein storing the first data validates the security device.

11. The method according to claim 9, comprising accessing the storage using the serialized human readable symbol to obtain information usable to authenticate the product.

12. The method according to claim 11, wherein the information usable to authenticate the product is based on the stored first and second data.

13. The method according to claim 11, wherein the information usable to authenticate the product comprises information associated with an entity to which the security device was sold.

14. The method according to claim 11, wherein the information usable to authenticate the product comprises information associated with a type of product for which the at least one security device was purchased.

15. The method according to claim 11, wherein the information usable to authenticate the product comprises the serialized human readable symbol.

16. The method according to claim 9, wherein the storage device comprises one or more databases.

17. A method of obtaining information from a security device comprising an optically variable device contained within a carrier associated with a substrate, wherein a bar code is rendered in the optically variable device, wherein a serialized human readable symbol is provided on a surface associated with the substrate, the method comprising:
reading the bar code according to a standard associated with the bar code to obtain first data; and
reading the bar code according to an algorithm not associated with the standard to obtain second data.

18. The method according to claim 17, wherein the bar code comprises a reduced space symbology (RSS) bar code.

19. A method of determining the authenticity of a security device comprising an optically variable device contained within a carrier associated with a substrate, wherein a bar code is rendered in the optically variable device, wherein a serialized human readable symbol is provided on a surface associated with the substrate, the method comprising:
receiving the serialized human readable symbol at a computer associated with the security device;
receiving data encoded in the bar code at the computer; and
the computer providing an indication that the security device is authentic if the serialized human readable symbol is related to the data obtained from the bar code based on an algorithm.

20. The method according to claim 19, wherein the bar code comprises a reduced space symbology (RSS) bar code.

21. A method of authenticating a product, comprising:
providing information to a computer, wherein the information is based on a security device associated with a product, wherein the security device comprises an optically variable device contained within a carrier associated with a substrate, wherein a bar code is rendered in the optically variable device, wherein a serialized human readable symbol is provided on a surface associated with the substrate;
the computer comparing the provided information with information stored in a storage device; and
the computer providing an indication that the product is authentic if the provided information matches the stored information.

22. A system for authenticating a product, the system comprising:
a computer for receiving a request from a first party to license a brand associated with a second party, wherein the computer forwards the request to the second party; and
at least one security device comprising an optically variable device contained within a carrier associated with a substrate, wherein a bar code is rendered in the optically variable device, wherein a serialized human readable symbol is provided on a surface associated with the substrate;
wherein the computer authorizes receipt of the at least one security device by the first party based on the computer receiving approval of the request by the second party, whereby the computer debits an amount from an account associated with the first party based on the first party receiving the at least one security device, and wherein the computer deposits a first portion of the amount in a first account and a second portion of the amount in a second account, wherein the first account is associated with the second party and the second account is associated with an operator of the computer

23. The system according to claim 22, further comprising a storage device in communication with the computer, wherein the product is authenticated by accessing information associated with the product from the storage device based on the computer receiving the human readable symbol.

24. The system according to claim 22, further comprising a storage device in communication with the computer, wherein the product is authenticated by accessing information associated with the product from the storage device based on the computer receiving data associated with scanning the bar code.

25. A security device for authenticating a product, the device comprising:
an optically variable device contained within a carrier associated with a substrate, wherein a bar code is rendered in the optically variable device, wherein the bar code comprises first data;
a serialized human readable symbol provided on a surface associated with the substrate, wherein the human readable symbol comprises second data;
wherein a user authenticates the product by accessing information associated with the authenticity of the product based on the human readable symbol and the bar code.

26. The device according to claim 25, wherein the information associated with the authenticity of the product comprises a serial number associated with the product.

27. The device according to claim 25, wherein the serialized human readable symbol comprises a serialized number associated with the security device.

28. A system for authenticating a product, the device comprising:
a security device comprising an optically variable device contained within a carrier associated with a substrate, wherein a bar code is rendered in the optically variable device, the bar code comprising data, wherein a serialized human readable symbol is provided on a surface associated with the substrate; and
a computer associated with the security device, wherein the computer receives the serialized human readable symbol and the data;
wherein the computer provides an indication that the security device is authentic if the serialized human readable symbol is related to the data obtained from the bar code based on an algorithm.

29. A security device for authenticating a product, the device comprising:
an optically variable device contained within a carrier associated with a substrate, wherein a bar code is rendered in the optically variable device, wherein a serialized human readable symbol is provided on a surface associated with the substrate; and
wherein the bar code is read according to a standard associated with the bar code to obtain first data, and wherein the bar code is read according to an algorithm not associated with the standard to obtain second data.

30. A system for authenticating a product, the system comprising:
at least one security device comprising an optically variable device contained within a carrier associated with a substrate, wherein a bar code is rendered in the optically variable device, wherein a serialized human readable symbol is provided on a surface associated with the substrate; and
a computer for receiving information based on the security device associated with a product, wherein the computer compares the received information with information stored in a storage device, whereby the computer provides an indication that the product is authentic if the provided information matches the stored information.
